(19) United States
(12) Patent Application Publication
(10) Pub. No.: US 2022/0106438 A1
(43) Pub. Date: Apr. 7, 2022

(54) SUBSTITUTED POLYSTYRENES AND METHODS

(71) Applicant: The Florida State University Research Foundation, Inc., Tallahassee, FL (US)

(72) Inventors: Justin G. Kennemur, Tallahassee, FL (US); Nam Quang Hai Nguyen, Tallahassee, FL (US)

(21) Appl. No.: 17/492,323

(22) Filed: Oct. 1, 2021

Related U.S. Application Data
(60) Provisional application No. 63/086,733, filed on Oct. 2, 2020.

(51) Int. Cl. C08G 61/08

(52) U.S. Cl. CPC C08G 61/08; C08G 2261/418

(57) ABSTRACT

Substituted polystyrenes and methods for making substituted polystyrenes. The substituted polystyrenes may be formed by a ring opening metathesis polymerization (ROMP). The ROMP may provide analogs having a precise periodicity. The substituted polystyrenes may have improved conductivities. The substituted polystyrenes may be substituted with N-(phenylsulfonyl)-N-(haloalkylsulfony)imide salts.

### CROSS-REFERENCE TO RELATED APPLICATIONS

This application claims priority to U.S. Provisional Patent Application No. 63/086,733, filed Oct. 2, 2020, which is incorporated herein by reference.

### BACKGROUND

Polystyrene-sulfonate (PSS) is an ionically charged polymer classified as a polyelectrolyte or ionomer depending on the concentration of the sulfonate ions present. It has been used in a number of applications. For example, PSS has been used in osmosis membranes for water purification, cation exchange resins for treatment of hyperkalemia, and electrolyte layers in battery applications and electronic devices. PSS also has been used as an additive to aid in bitumen strength or oil remediation. Its ubiquitous use is largely due to the fact that PSS represents one of the few commercially available options for polyelectrolytes due, at least in part, to the fact that its parent precursor, polystyrene (PS), is produced in large quantities. PSS, however, often is considered too brittle due to its glassy state and T_{g}.

Copolymers can present opportunities to design materials with different and/or potentially advantageous properties when compared to homopolymers of their individual constituents. Although polyethylene and polystyrene are ubiquitous plastics, the synthesis of ethylene-styrene (ES) copolymers has been challenging due, at least in part, to the markedly different monomer reactivities, and, as a result, has been deemed non-viable in view of the limitations of traditional Ziegler-Natta catalyst systems. Ethylene and styrene monomers can be copolymerized to form ethylene-styrene copolymers, however, the catalysts used are complex, styrene incorporation is not precise, and/or it can be difficult to achieve high styrene content due at least in part to the differences in reactivity between ethylene and styrene.

The advent of well-defined “single-site” or molecular catalysts over the last few decades has brought new attention to the efficacy and utility of ES copolymers. A broad scope of material properties are realized when traversing from low to high styrene (S) content which can translate to a variety of applications for compatibilizers, packaging, films, foams, automobiles, construction materials, and/or bitumen modifiers. However, producing ES copolymers with high S content (>70% w/w) remains a formidable challenge, due to the fact that high S feed ratios typically are required and/or the processes can create difficult issues regarding homopolymer formation, product irreproducibility, and/or the discrete/complex nature of the molecular catalysts. Generally, it is known that the copolymerization of two different monomers can create a copolymer having a statistical distribution of the two repeat units, rather than a precise distribution.

An alternative strategy to ethylene copolymers is ring-opening metathesis polymerization (ROMP) of strained monocyclic alkenes or acyclic diene metathesis (ADMET) polymerization of linear dienes followed by hydrogenation of the backbone olefins. In both cases, a singular monomer can be used to impart periodic chain branching with functionalities that are analogous to copolymer systems. Precision polymers are a subset of these materials that incorporate branches at exactly spaced periodicity along a polyethylene chain. The region-specific branching of these systems can lead to well-defined properties for specialty applications.

Precision ES copolymers have been described in U.S. Pat. No. 10,640,587, which is incorporated by reference herein.

Bis-(trifluoromethylsulfonyl)imide lithium salt (TFSLi) is a leading ionic liquid for ion conductivity of lithium. The enhanced stabilization of the imide anion through resonance with the two sulfonyl groups is believed to create a weaker electrostatic association with lithium. Hence, the lithium ions may conduct (i.e., transport) easier with the counteranion.

There remains a need for copolymers that have improved conductivities, are single ion conductors, are amorphous, have a relatively low glass transition temperature, have reduced phenyl branch periodicity, and/or overcome one or more of the foregoing disadvantages regarding copolymers, such as PSS and highly-sulfonated PSS.

### BRIEF SUMMARY

Provided herein are polymers, and methods of making polymers that address one or more of the foregoing needs and/or disadvantages. For example, provided herein are embodiments of precision polymers that are single ion conductors. The polymers provided herein may—additionally or alternatively—have improved conductivities and/or a glass transition temperature of about 5° C. to about 40° C., which is believed to offer more flexibility and/or tractability at ambient temperature than PS and/or PSS.

In one aspect, polymers are provided. In some embodiments, the polymers include a repeat unit according to Formula (A):

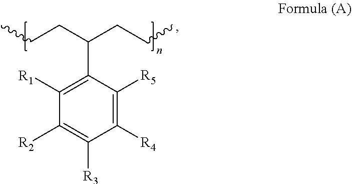

wherein R₁-R₅ are independently selected from (i) hydrogen, (ii) a substituent of formula (a), (iii) a substituent of formula (b), or (iv) a monovalent C₁-C₁₀ hydrocarbyl;

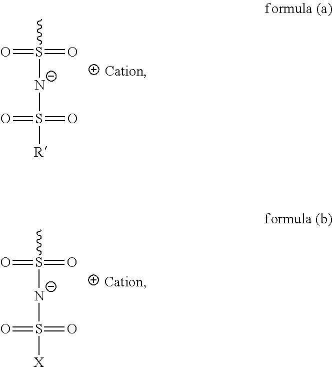

wherein R′ is a halogenated C₁-C₅ hydrocarbyl, and X is a halogen. In some embodiments, at least one of R₁-R₅ is the substituent of formula (a) or the substituent of formula (b). In some embodiments, n is 1 to 10,000.

In some embodiments, the polymers include repeat units according to Formula (B):

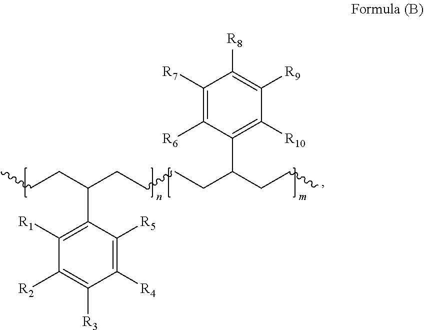

wherein R₁-R₁₀ are independently selected from (i) hydrogen, (ii) a substituent of formula (a), (iii) a substituent of formula (b), or (iv) a monovalent C₁-C₁₀ hydrocarbyl;

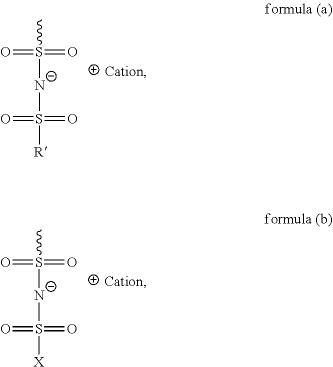

wherein R′ is a halogenated C₁-C₅ hydrocarbyl, and X is a halogen. In some embodiments, at least one of R₁-R₅ is the substituent of formula (a) or the substituent of formula (b). In some embodiments, n and m independently are 1 to 10,000.

In another aspect, methods of preparing polymers are provided. In some embodiments, the methods of making polymers include providing a polymer of formula (I)—

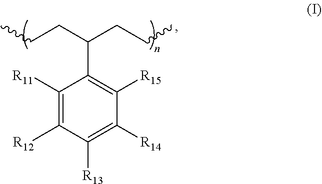

wherein R₁₁-R₁₅ are independently selected from (i) hydrogen, (ii) a sulfonyl halide, or (iii) a monovalent C₁-C₁₀ hydrocarbyl, wherein at least one of R₁₁-R₁₅ is the sulfonyl halide, and wherein n is 1 to 10,000; and contacting the polymer of formula (I) with a halo-C₁-C₅ alkylsulfonamide or a halosulfonamide to convert the sulfonyl halide to a substituent of formula (a) or a substituent of formula (b);

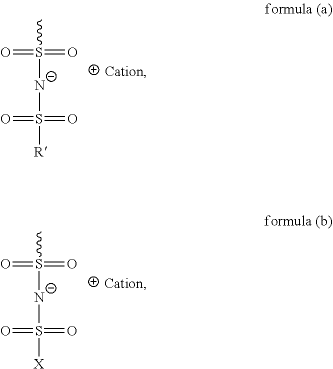

wherein R′ is a halogenated C₁-C₅ hydrocarbyl, and X is a halogen.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### DETAILED DESCRIPTION

In some embodiments, the polymers herein include a repeat unit having the following structure:

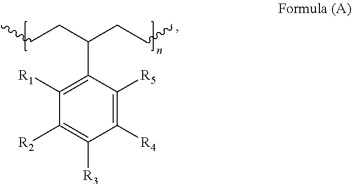

wherein R₁-R₅ are independently selected from (i) hydrogen, (ii) a substituent of formula (a), (iii) a substituent of formula (b), or (iv) a monovalent C₁-C₁₀ hydrocarbyl;

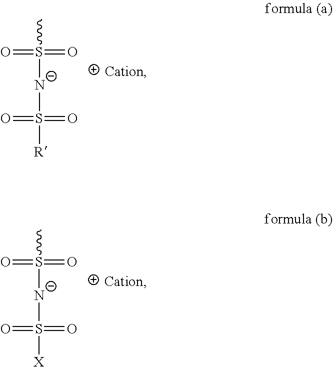

wherein R′ is a halogenated C₁-C₅ hydrocarbyl, and X is a halogen; wherein at least one of R₁-R₅ is the substituent of formula (a) or the substituent of formula (b); and wherein n is 1 to 10,000.

In some embodiments, R₁, R₂, R₄, and R₅ are hydrogen, and R₃ is a substituent of formula (a) or a substituent of formula (b). For example, when R₁, R₂, R₄, and R₅ are hydrogen, and R₃ is a substituent of formula (a), the polymers herein may include a repeat unit having the following structure:

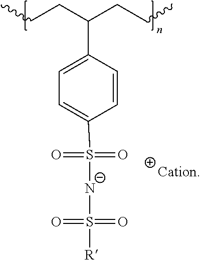

In some embodiments, R₂, R₃, R₄, and R₅ are hydrogen, and R₁ is a substituent of formula (a) or a substituent of formula (b). In some embodiments, R₁, R₃, R₄, and R₅ are hydrogen, and R₂ is a substituent of formula (a) or a substituent of formula (b). In some embodiments, R₁, R₂, R₃, and R₅ are hydrogen, and R₄ is a substituent of formula (a) or a substituent of formula (b). In some embodiments, R₁, R₂, R₃, and R₄ are hydrogen, and R₅ is a substituent of formula (a) or a substituent of formula (b).

In some embodiments, “n” of Formula (A) is about 200 to about 1,200, about 300 to about 1,075, about 500 to about 1,075, about 500 to about 1,000, about 500 to about 800, or about 600 to about 700.

In some embodiments, R′ is a perhalogenated C₁-C₅ hydrocarbyl, a perhalogenated C₁-C₄ hydrocarbyl, a perhalogenated C₁-C₃ hydrocarbyl, a perhalogenated C₁-C₂ hydrocarbyl, or a perhalogenated C₁ hydrocarbyl. In some embodiments, the perhalogenated C₁ hydrocarbyl is a perfluorinated methyl, and the substituent of formula (a) has the following structure:

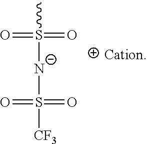

The substituent of formula (a) or the substituent of formula (b) may include any cation. The cation may be organic or inorganic. In some embodiment, the cation is an inorganic cation, such as lithium.

In some embodiments, the polymers herein comprise the repeat units of Formula (B):

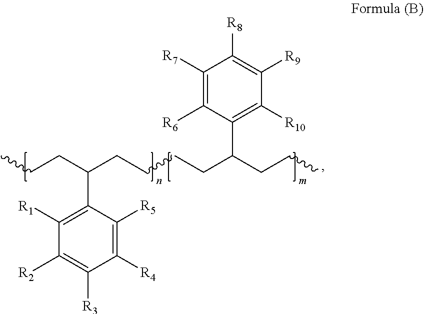

wherein R₁-R₁₀ are independently selected from (i) hydrogen, (ii) a substituent of formula (a), (iii) a substituent of formula (b), or (iv) a monovalent C₁-C₁₀ hydrocarbyl;

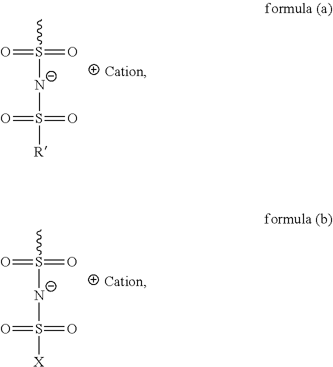

wherein R′ is a halogenated C₁-C₅ hydrocarbyl, and X is a halogen; wherein at least one of R₁-R₅ is the substituent of formula (a) or the substituent of formula (b), and wherein n and m independently are 1 to 10,000.

In some embodiments, at least one of R₁-R₅ may differ from at least one of R₆-R₁₀ in the polymers of Formula (B). Therefore, the term “polymer” as used herein, refers to and includes both polymers and copolymers. The copolymers, as described herein, may be block copolymers.

The degree of substitution of (i) the substituent of formula (a), (ii) the substituent of formula (b), or (iii) the substituent of formula (a) and the substituent of formula (b), in total, of the polymers provided herein may be about 1% to about 150%, about 1% to about 125%, about 1 to about 100%, about 75% to about 125%, or about 80% to about 120%. The phrase “in total” indicates that when a polymer includes both the substituent of formula (a) and the substituent of formula (b), the sum of the degree of substitution of the substituent of formula (a) and the degree of substituent of the substituent of formula (b) satisfies one of the foregoing ranges, e.g., “about 1% to about 150%.”

In some embodiments, at least one of R₆-R₁₀ is the substituent of formula (a) or the substituent of formula (b), and the degree of substitution is at least 100%, about 100% to about 150%, about 100% to about 125%, or about 100% to about 110%.

In some embodiments, the sum of “m” and “n” of Formula (B) is about 200 to about 1,200, about 300 to about 1,075, about 500 to about 1,075, about 500 to about 1,000, about 500 to about 800, or about 600 to about 700.

The “degree of substitution of the substituent of formula (a) [or formula (b)]”, which is provided as a percentage herein, generally indicates the average number of substituents of formula (a) [or formula (b)] per phenyl pendant group of the polymers provided herein. For example, a degree of substitution of 100% indicates an average of one substituent of formula (a) [or formula (b)] per phenyl pendant group. Degrees of substitution less than 100% indicate an average of less than one substituent of formula (a) [or formula (b)] per phenyl pendant group, and degrees of substitution greater than 100% indicate an average of more than one substituent of formula (a) [or formula (b)] per phenyl pendant group, thereby indicating that a least a portion of the phenyl pendant groups should be substituted with more than one substituent of formula (a) [or formula (b)]. For example, a degree of substitution of 80% indicates that an average of 80 out of every 100 phenyl pendant groups are substituted with one substituent of formula (a) [or formula (b)].

Generally, the polymers of Formula (B) herein may include any ratio of “m” to “n” in order to achieve a desired degree of substitution. For example, R₃ may be a substituent of formula (a); R₁, R₂, and R₄-R₁₀ may be hydrogen; and the ratio of n:m may be 80:20, thereby imparting the polymer with a degree of substitution of 80%.

The polymers may include any end groups known in the art, including, but not limited to end groups derived from ethyl vinyl ether, or by end groups derived from telechelic chain transfer agents.

The polymers herein may be cross-linked. The cross-linking may be achieved via olefins in a polymer's “backbone”. Therefore, as used herein, the symbol “ [symbol] ” may represent one bond in polymers that are not cross-linked, or two bonds in polymers that are cross-linked. For example, when the polymers are not cross-linked, the symbol “ [symbol] ” may represent one bond between the carbon atom of the monomer and [1] an adjacent monomer of the polymer chain, or [2] an end group; and when the polymers are cross-linked, the symbol

“ [symbol] ” may represent two bonds, such as a first bond between the carbon atom of the monomer and [1] an adjacent monomer of the polymer chain or [2] an end group, and a second bond between the carbon atom of the monomer and [1] a non-adjacent monomer of the polymer chain or [2] a monomer of a different polymer chain. The terms “monomer” and “repeat unit” are used interchangeably herein.

The glass transition temperature (T_{g}) of the polymers provided herein may be about 5° C. to about 145° C., about 5° C. to about 125° C., about 5° C. to about 100° C., about 5° C. to about 75° C., about 5° C. to about 50° C., about 5° C. to about 40° C., about 10° C. to about 30° C., about 15° C. to about 20° C., or about 17° C.

The polymers provided herein may be employed in block copolymers. For example, the products provided herein may be employed in block copolymers through utilization of chain transfer agents which may install functionalities for sequential growth of alternative polymer segments.

### Methods of Making Polymers

Methods of making polymers, such as those of Formula (A) and Formula (B), respectively, are provided herein. In some embodiments, the methods include providing a polymer of formula (I)—

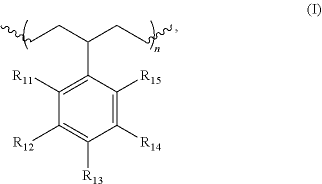

wherein R₁₁-R₁₅ are independently selected from (i) hydrogen, (ii) a sulfonyl halide, or (iii) a monovalent C₁-C₁₀ hydrocarbyl, wherein at least one of R₁₁-R₁₅ is the sulfonyl halide, and wherein n is 1 to 10,000; and contacting the polymer of formula (I) with a halo-C₁-C₅ alkylsulfonamide or a halosulfonamide to convert the sulfonyl halide to a substituent of formula (a) or a substituent of formula (b);

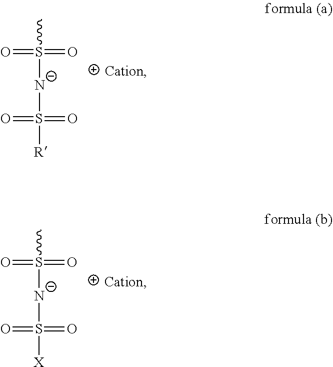

wherein R′ is a halogenated C₁-C₅ hydrocarbyl, and X is a halogen.

In some embodiments, the sulfonyl halide is a sulfonyl chloride.

In some embodiments, the contacting of the polymer of formula (I) with the halo-C₁-C₅ alkylsulfonamide or the halosulfonamide occurs (i) in the presence of dimethylaminopyridine, trimethylamine, acetonitrile, or a combination thereof, (ii) at a temperature of about 20° C. to about 30° C., or (iii) a combination thereof.

In some embodiments, the halo-C₁-C₅ alkylsulfonamide is a fluoro-C₁-C₅ alkylsulfonamide, such as a perfluoro-C₁-C₅ alkylsulfonamide. In some embodiments, the fluoro-C₁-C₅ alkylsulfonamide is CF₃SO₂NH₂.

The phrases “C₁-C₁₀ hydrocarbyl” and the like, as used herein, generally refer to aliphatic, aryl, or arylalkyl groups containing 1 to 10 carbon atoms. The phrase “C₁-C₅ alkyl” and the like, as used herein, generally refer to alkyl groups containing 1 to 5 carbon atoms. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to 10 carbon atoms, 2 to 8 carbon atoms, 4 to 6 carbon atoms, etc. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl and dodecyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, tolyl, xylyl, mesityl, benzyl, and the like, including any heteroatom substituted derivative thereof.

Unless otherwise indicated, the term “substituted,” when used to describe a chemical structure or moiety, refers to a derivative of that structure or moiety wherein one or more of its hydrogen atoms is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)O— alkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

The terms “a,” “an,” and “the” are intended to include plural alternatives, e.g., at least one. For instance, the disclosure of “a C₁-C₁₀ hydrocarbyl,” “a monomer,” and the like, is meant to encompass one, or mixtures or combinations of more than one C₁-C₁₀ hydrocarbyl, monomer, and the like, unless otherwise specified.

In the descriptions provided herein, the terms “includes,” “is,” “containing,” “having,” and “comprises” are used in an open-ended fashion, and thus should be interpreted to mean “including, but not limited to.” When compositions or methods are claimed or described in terms of “comprising” various steps or components, the devices, systems, or methods can also “consist essentially of” or “consist of” the various steps or components, unless stated otherwise.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in one embodiment, that “the glass transition temperature (T_{g}) of the polymer is about 15° C. to about 20° C.”. This range should be interpreted as encompassing values in a range of about 15° C. to about 20° C., and further encompasses “about” each of 16° C., 17° C., 18° C., and 19° C., including any ranges and sub-ranges between any of these values.

The processes described herein may be carried out or performed in any suitable order as desired in various implementations. Additionally, in certain implementations, at least a portion of the processes may be carried out in parallel. Furthermore, in certain implementations, less than or more than the processes described may be performed.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims.

### EMBODIMENTS

The following listing of embodiments describes various features and combinations of features that may be present in the compositions and methods described herein:

Embodiment 1. A polymer comprising a repeat unit according to Formula (A):

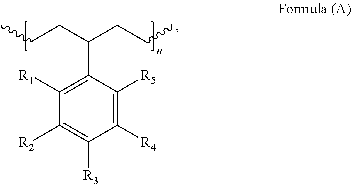

wherein R₁-R₅ are independently selected from (i) hydrogen, (ii) a substituent of formula (a), (iii) a substituent of formula (b), or (iv) a monovalent C₁-C₁₀ hydrocarbyl;

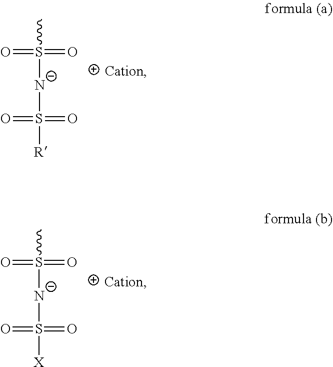

wherein R′ is a halogenated C₁-C₅ hydrocarbyl, and X is a halogen; wherein at least one of R₁-R₅ is the substituent of formula (a) or the substituent of formula (b); and wherein n is 1 to 1,000,000, 1 to 500,000, 1 to 100,000, 1 to 50,000, 1 to 10,000, 1 to 7,500, 1 to 5,000, 1 to 2,500, 1 to 1,000, 1,000 to 10,000, 2,500 to 10,000, 5,000 to 10,000, or 7,500 to 10,000.

Embodiment 2. A polymer comprising repeat units according to Formula (B):

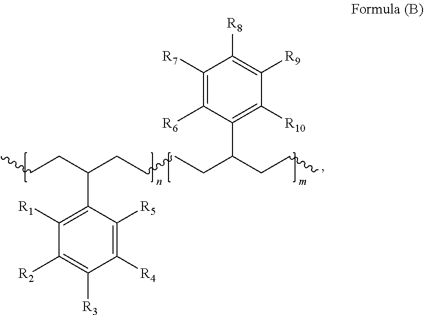

wherein R₁-R₁₀ are independently selected from (i) hydrogen, (ii) a substituent of formula (a), (iii) a substituent of formula (b), or (iv) a monovalent C₁-C₁₀ hydrocarbyl;

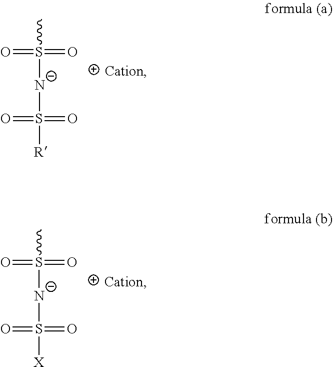

wherein R′ is a halogenated C₁-C₅ hydrocarbyl, and X is a halogen; wherein at least one of R₁-R₅ is the substituent of formula (a) or the substituent of formula (b), and wherein n and m independently are 1 to 1,000,000, 1 to 500,000, 1 to 100,000, 1 to 50,000, 1 to 10,000, 1 to 7,500, 1 to 5,000, 1 to 2,500, 1 to 1,000, 1,000 to 10,000, 2,500 to 10,000, 5,000 to 10,000, or 7,500 to 10,000.

Embodiment 3. A method of making a polymer, the method comprising providing a polymer of formula (I)—

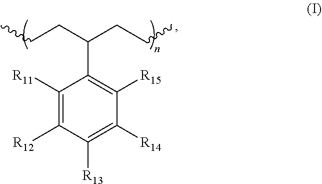

wherein R₁₁-R₁₅ are independently selected from (i) hydrogen, (ii) a sulfonyl halide, or (iii) a monovalent C₁-C₁₀ hydrocarbyl, wherein at least one of R₁₁-R₁₅ is the sulfonyl halide, and wherein n is 1 to 1,000,000, 1 to 500,000, 1 to 100,000, 1 to 50,000, 1 to 10,000, 1 to 7,500, 1 to 5,000, 1 to 2,500, 1 to 1,000, 1,000 to 10,000, 2,500 to 10,000, 5,000 to 10,000, or 7,500 to 10,000; and contacting the polymer of formula (I) with a halo-C₁-C₅ alkylsulfonamide or a halosulfonamide to convert the sulfonyl halide to a substituent of formula (a) or a substituent of formula (b);

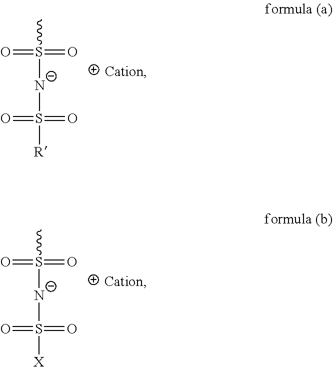

wherein R′ is a halogenated C₁-C₅ hydrocarbyl, and X is a halogen.

Embodiment 4. The polymers or methods of any of Embodiments 1 to 3, wherein R′ is a perhalogenated C₁-C₅ hydrocarbyl, a perhalogenated C₁-C₄ hydrocarbyl, a perhalogenated C₁-C₃ hydrocarbyl, a perhalogenated C₁-C₂ hydrocarbyl, or a perhalogenated C₁ hydrocarbyl.

Embodiment 5. The polymers or methods of any one of Embodiments 1 to 4, wherein R′ is a trifluoromethyl, and the substituent of formula (a) has the following structure:

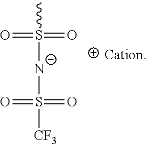

Embodiment 6. The polymers or methods of any one of Embodiments 1 to 5, wherein the cation of the substituent of formula (a) or the substituent of formula (b) is an inorganic cation or an organic cation, such as an ammonium cation (e.g., a C₁-C₁₀ hydrocarbyl ammonium).

Embodiment 7. The polymers or methods of any one of Embodiments 1 to 6, wherein the inorganic cation comprises lithium.

Embodiment 8. The polymers or methods of any one of Embodiments 1 to 7, wherein the degree of substitution of (i) the substituent of formula (a), (ii) the substituent of formula (b), or (iii) the substituent of formula (a) and the substituent of formula (b), in total, of the polymers is about 1% to about 200%, about 1% to about 175%, about 1% to about 150%, about 1% to about 125%, about 1 to about 100%, about 75% to about 125%, or about 80% to about 120%.

Embodiment 9. The polymers or methods of any one of Embodiments 1 to 8, wherein the polymer has a degree of substitution of (i) the substituent of formula (a), (ii) the substituent of formula (b), or (iii) the substituent of formula (a) and the substituent of formula (b), in total, of about 80% to about 120%.

Embodiment 10. The polymers or methods of any one of Embodiments 1 to 9, wherein at least one of R₆-R₁₀ is (i) the substituent of formula (a), and the polymer has a degree of substitution of the substituent of formula (a) of about 100% to about 120%; or (ii) the substituent of formula (b), and the polymer has a degree of substitution of the substituent of formula (b) of about 100% to about 120%.

Embodiment 11. The polymers or methods of any one of Embodiments 1 to 10, wherein the glass transition temperature (T_{g}) of the polymers is about 5° C. to about 145° C., about 5° C. to about 125° C., about 5° C. to about 100° C., about 5° C. to about 75° C., about 5° C. to about 50° C., about 5° C. to about 40° C., about 10° C. to about 30° C., about 15° C. to about 20° C., or about 17° C.

Embodiment 12. The polymers or methods of any one of Embodiments 1 to 11, wherein the polymer is at least partially cross-linked.

Embodiment 13. The polymers or methods of any one of Embodiments 1 to 12, wherein R₁, R₂, R₄, and R₅ are hydrogen, and R₃ is the substituent of formula (a) or the substituent of formula (b); wherein R₂, R₃, R₄, and R₅ are hydrogen, and R₁ is a substituent of formula (a) or a substituent of formula (b); wherein R₁, R₃, R₄, and R₅ are hydrogen, and R₂ is a substituent of formula (a) or a substituent of formula (b); or wherein R₁, R₂, R₃, and R₅ are hydrogen, and R₄ is a substituent of formula (a) or a substituent of formula (b).

Embodiment 14. The polymers or methods of any one of Embodiments 1 to 13, wherein n, such as n of Formula (A), is about 200 to about 1,200, about 300 to about 1,075, about 500 to about 1,075, about 500 to about 1,000, about 500 to about 800, or about 600 to about 700.

Embodiment 15. The polymers or methods of any one of Embodiments 1 to 14, wherein the sum of “m” and “n” of Formula (B) is about 200 to about 1,200, about 300 to about 1,075, about 500 to about 1,075, about 500 to about 1,000, about 500 to about 800, or about 600 to about 700.

Embodiment 16. The polymers or methods of any one of Embodiments 1 to 15, wherein X is fluorine, chlorine, bromine, iodine, or a combination thereof.

Embodiment 17. The polymers or methods of any one of Embodiments 1 to 16, wherein the polymers include any end groups known in the art, including, but not limited to end groups derived from ethyl vinyl ether, or by end groups derived from telechelic chain transfer agents.

Embodiment 18. The polymers or methods of any one of Embodiments 1 to 17, wherein the polymers are block copolymers.

Embodiment 19. The polymers or methods of any one of Embodiments 1 to 18, wherein the sulfonyl halide is a sulfonyl chloride.

Embodiment 20. The polymers or methods of any one of Embodiments 1 to 19, wherein the contacting of the polymer of formula (I) with the halo-C₁-C₅ alkylsulfonamide or the halosulfonamide occurs (i) in the presence of dimethylaminopyridine, trimethylamine, acetonitrile, or a combination thereof, (ii) at a temperature of about 20° C. to about 30° C., or (iii) a combination thereof.

Embodiment 21. The polymers or methods of any one of Embodiments 1 to 20, wherein the halo-C₁-C₅ alkylsulfonamide is a perfluoro-C₁-C₅ alkylsulfonamide, such as CF₃SO₂NH₂.

### Examples

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Synthesis of Polymer Substituted with Bis-Sulfonyl Lithium Salt

In this example, a precision phenylsulfonic acid sodium salt was converted to N-(phenylsulfonyl)-N-(trifluoromethylsulfony)imide lithium salt. It was believed that the synthesis of this example proceeded according to the following scheme:

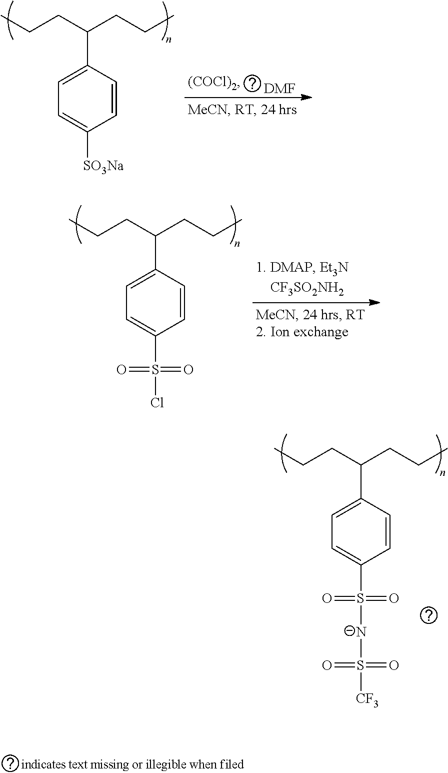

In this example, a precision polymer including sulfonate substituents was prepared as a starting material using the methods described at U.S. Pat. No. 10,640,587, which is incorporated by reference herein.

The sulfonate substituents were converted to sulfonyl chloride substituents by contacting the polymer starting material with the reagents depicted in the foregoing scheme, which included oxalyl chloride.

The sulfonyl chloride groups were then converted to bis-(trifluorosulfonyl)imide lithium salt groups by contacting the sulfonyl chloride substituents with the reagents depicted at the foregoing scheme, which included CF₃SO₂NH₂.

Yields of at least 75% were achieved, and it is expected that yields range from 75% to 99%.

We claim:

1. A polymer comprising repeat units according to Formula (B): 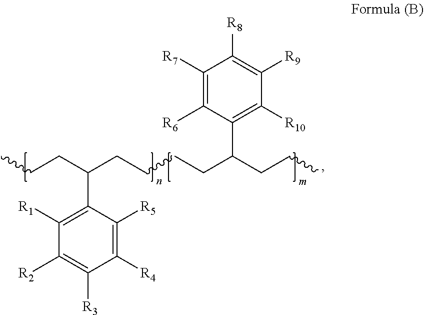
wherein R₁-R₁₀ are independently selected from (i) hydrogen, (ii) a substituent of formula (a), (iii) a substituent of formula (b), or (iv) a monovalent C₁-C₁₀ hydrocarbyl; 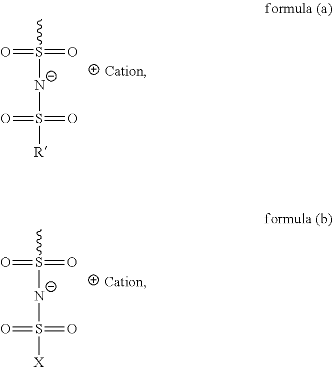
wherein R′ is a halogenated C₁-C₅ hydrocarbyl, and X is a halogen;
wherein at least one of R₁-R₅ is the substituent of formula (a) or the substituent of formula (b), and
wherein n and m independently are 1 to 10,000.

2. The polymer of claim 1, wherein R′ is a perhalogenated C₁-C₅ hydrocarbyl.

3. The polymer of claim 2, wherein R′ is a trifluoromethyl, and the substituent of formula (a) has the following structure:

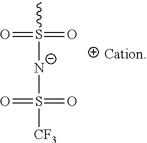

4. The polymer of claim 1, wherein the cation of the substituent of formula (a) or the substituent of formula (b) is an inorganic cation.

5. The polymer of claim 4, wherein the inorganic cation comprises lithium.

6. The polymer of claim 1, wherein the polymer has a degree of substitution of (i) the substituent of formula (a), (ii) the substituent of formula (b), or (iii) the substituent of formula (a) and the substituent of formula (b), in total, of about 1% to about 125%.

7. The polymer of claim 1, wherein the polymer has a degree of substitution of (i) the substituent of formula (a), (ii) the substituent of formula (b), or (iii) the substituent of formula (a) and the substituent of formula (b), in total, of about 80% to about 120%.

8. The polymer of claim 1, wherein at least one of R₆-R₁₀ is—
the substituent of formula (a), and the polymer has a degree of substitution of the substituent of formula (a) of about 100% to about 120%; or
the substituent of formula (b), and the polymer has a degree of substitution of the substituent of formula (b) of about 100% to about 120%.

9. The polymer of claim 1, wherein the polymer has a glass transition temperature (T_{g}) of about 5° C. to about 145° C.

10. The polymer of claim 1, wherein the polymer has a glass transition temperature (T_{g}) of about 10° C. to about 30° C.

11. The polymer of claim 1, wherein the polymer is at least partially cross-linked.

12. A polymer comprising a repeat unit according to Formula (A): 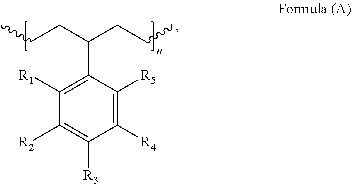
wherein R₁-R₅ are independently selected from (i) hydrogen, (ii) a substituent of formula (a), (iii) a substituent of formula (b), or (iv) a monovalent C₁-C₁₀ hydrocarbyl; 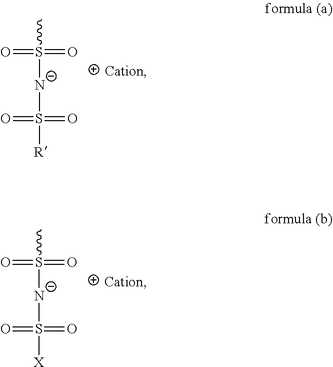
wherein R′ is a halogenated C₁-C₅ hydrocarbyl, and X is a halogen;
wherein at least one of R₁-R₅ is the substituent of formula (a) or the substituent of formula (b); and
wherein n is 1 to 10,000.

13. The polymer of claim 12, wherein the polymer has a glass transition temperature (T_{g}) of about 5° C. to about 145° C.

14. The polymer of claim 12, wherein the polymer has a glass transition temperature (T_{g}) of about 10° C. to about 30° C.

15. The polymer of claim 12, wherein R₁, R₂, R₄, and R₅ are hydrogen, and R₃ is the substituent of formula (a) or the substituent of formula (b).

16. The polymer of claim 12, wherein R′ is a perhalogenated C₁-C₅ hydrocarbyl.

17. The polymer of claim 16, wherein R′ is a trifluoromethyl.

18. The polymer of claim 12, wherein the cation of the substituent of formula (a) or the substituent of formula (b) is an inorganic cation.

19. The polymer of claim 12, wherein the polymer is at least partially cross-linked.

20. A method of making a polymer, the method comprising:
providing a polymer of formula (I)— 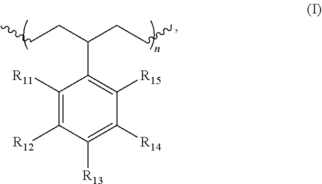
wherein R₁₁-R₁₅ are independently selected from (i) hydrogen, (ii) a sulfonyl halide, or (iii) a monovalent C₁₁-C₁₀ hydrocarbyl, wherein at least one of R₁₁-R₁₅ is the sulfonyl halide, and wherein n is 1 to 10,000; and
contacting the polymer of formula (I) with a halo-C₁-C₅ alkylsulfonamide or a halosulfonamide to convert the sulfonyl halide to a substituent of formula (a) or a substituent of formula (b); 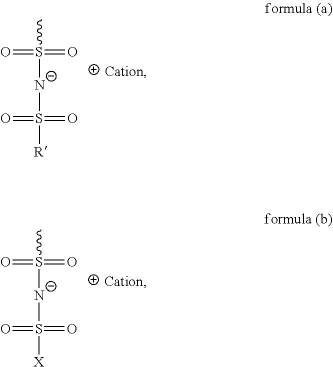
wherein R′ is a halogenated C₁-C₅ hydrocarbyl, and X is a halogen.
